(19) United States
(12) Patent Application Publication
(10) Pub. No.: US 2026/0316130 A1
(43) Pub. Date: Oct. 15, 2026

(54) TIRE RECOVERY METHOD, STORAGE MEDIUM, ELECTRONIC APPARATUS

(71) Applicants: Eve Rubber Institute Co., Ltd., Qingdao (CN); Sailun Group Co., Ltd., Qingdao (CN)

(72) Inventors: Feng LIU, Qingdao (CN); Bin WANG, Qingdao (CN); Weijie JIA, Qingdao (CN); Dan ZHANG, Qingdao (CN); Yudian SONG, Qingdao (CN)

(73) Assignees: Eve Rubber Institute Co., Ltd., Qingdao (CN); Sailun Group Co., Ltd., Qingdao (CN)

(21) Appl. No.: 19/688,593

(22) Filed: May 27, 2026

Related U.S. Application Data
(63) Continuation of application No. PCT/CN2025/133521, filed on Nov. 7, 2025.

(30) Foreign Application Priority Data
Nov. 8, 2024 (CN) 202411597689.0

(51) Int. Cl. B09B 3/70; B09B 3/35; B09B 101/80; C08J 11/24

(52) U.S. Cl. CPC B09B 3/70; B09B 3/35; C08J 11/24; B09B 2101/80; C08J 2309/06

(57) ABSTRACT

Some embodiments of the present disclosure provides a tire recovery method, a storage medium, an electronic apparatus. The tire recovery method includes: acquiring waste tires and pre-treating the waste tires to obtain waste materials to be recovered; adding a first set amount of the waste materials to be recovered, a first set concentration of a solvent, a second set amount of a functionalized compound, and a third set amount of a catalyst into a batch reactor, and a chemical reaction occurring under a first set condition to obtain a first product system; and post-treating the first product system to obtain a product; wherein the first set condition comprises: a reaction time of 1 to 6 hours and a reaction temperature of 80 °C to 120 °C.

### CROSS-REFERENCE TO RELATED APPLICATIONS

This application is a Continuation of PCT Patent Application No. PCT/CN2025/133521 having International filing date of Nov. 7, 2025, which claims the benefit of priority of China Patent Application No. 202411597689.0 filed on Nov. 8, 2024. The contents of the above applications are all incorporated by reference as if fully set forth herein in their entirety.

### TECHNICAL FIELD

The present disclosure relates to the technical field of tire recycling, and in particular, to a tire recovery method, a storage medium, an electronic apparatus.

### BACKGROUND

One of the core processes in the tire manufacturing industry is vulcanization, which chemically crosslinks elastomer molecular chains to construct a stable three-dimensional network structure, thereby imparting excellent mechanical performance and durability to a tire. However, the irreversibility of the vulcanization process also means that vulcanized rubber in waste tires cannot be directly reprocessed by means of melting or dissolution, which constitutes a major technical obstacle to the recycling of tires. Since the invention of vulcanized rubber, the recovery and reuse of waste tires have long troubled the rubber industry, and has become a challenge in urgent need of breakthroughs.

At present, waste tire recovery technologies are mainly divided into three major categories: rubber crushing, reuse, and devulcanization. The devulcanization technology aims to break polysulfide, disulfide and monosulfide bonds in vulcanized rubber, while for rubber vulcanized by peroxide or resin, it is necessary to cleave stronger carbon-carbon bonds or other chemical bonds. However, the devulcanized rubber, due to its molecular chain breakage and broadening of molecular weight distribution, tends to have decreased quality, resulting in a limited application range thereof, and the devulcanized rubber is difficult to use as raw materials for high-performance rubber products.

### SUMMARY

A main object of the present disclosure is to provide a tire recovery method, a storage medium, an electronic apparatus, so as to solve the problem in the related art that it is difficult for devulcanized rubber to be used as raw materials for high-performance rubber products due to molecular chain breakage and broadening of molecular weight distribution of the devulcanized rubber.

In order to achieve the object, in some embodiments of the present disclosure, a tire recovery method is provided, and the tire recovery method includes:
waste tires are acquired and pre-treated to obtain waste materials to be recovered;
a first set amount of the waste materials to be recovered, a first set concentration of a solvent, a second set amount of a functionalized compound, and a third set amount of a catalyst are added into a batch reactor, and a chemical reaction occurs under a first set condition to obtain a first product system; and
the first product system is post-treated to obtain a product;
wherein the first set condition includes: a reaction time of 1 to 6 hours and a reaction temperature of 80 °C to 120 °C.

In some embodiments of the present disclosure, a functional group at one terminal of the functionalized compound is any one of maleic anhydride, sulfhydryl group and amine group, and an other terminal of the functionalized compound is a group which includes one of filler-dispersing, anti-aging or anti-reversion.

In some embodiments of the present disclosure, a step that waste tires are acquired and pre-treated to obtain waste materials to be recovered, includes:
the waste tires are crushed to obtain initial waste materials to be recovered, wherein the initial waste materials to be recovered have a shape in any one or more of block shape, sheet shape and powder shape; and
the initial waste materials to be recovered are controlled to be dried at a set drying temperature, so as to obtain the waste materials to be recovered;
wherein the set drying temperature is 100 °C.

In some embodiments of the present disclosure, before a step that the chemical reaction occurs under the first set condition, the method further includes:
an inert gas is introduced into the batch reactor to remove oxygen from the batch reactor;
wherein the inert gas is any one of nitrogen and carbon dioxide, or the inert gas is a mixed gas of nitrogen and carbon dioxide.

In some embodiments of the present disclosure, a residence time of the inert gas in the batch reactor is controlled to be 30 minutes; and a number of times of introducing the inert gas into the batch reactor is set to at least three times, and a time interval between every two adjacent times of introducing the inert gas is 5 min to 30 min.

In some embodiments of the present disclosure, a residence time of the inert gas in the batch reactor is controlled to be 30 minutes; or a number of times of introducing the inert gas into the batch reactor is set to at least three times, and a time interval between every two adjacent times of introducing the inert gas is 5 min to 30 min.

In some embodiments of the present disclosure the solvent is any one of an alkane, a halogenated hydrocarbon, and a lipid; and

### The First Set Concentration Is 5% to 40%.

In some embodiments of the present disclosure, the solvent is any one of an alkane, a halogenated hydrocarbon, and a lipid; or the first set concentration is 5% to 40%.

In some embodiments of the present disclosure, a step of that the first product system is post-treated to obtain the product, includes:
an alcohol substance is introduced into the batch reactor, and mixed with the first product system, to obtain the product and an initial solvent;
wherein the alcohol substance is any one of methanol, ethanol, propanol, butanol, pentanol and hexanol.

In some embodiments of the present disclosure, after a step that the product and the solvent are obtained, the method further includes:
the initial solvent is sequentially separated and rectified to obtain the solvent.

In some embodiments of the present disclosure, the initial waste materials to be recovered have a size from 50 mesh to 200 mesh.

In some embodiments of the present disclosure, the third set amount is 1/100 to 1/8000 of a total molar amount of the functionalized compound.

In some embodiments of the present disclosure, provided is a computer-readable storage medium, the computer-readable storage medium storing a computer program, wherein the computer program is configured to execute, when running, a tire recovery method as described above.

In some embodiments of the present disclosure, provided is an electronic apparatus, including a memory, a processor and a computer program stored in the memory and executable on the processor, wherein the processor executes a tire recovery method as described above by the computer program.

By applying the technical solution of the present disclosure, the waste tires are subjected to steps such as crushing and drying in the pre-treatment stage, such that the uniformity and reactivity of raw materials are effectively improved, and the subsequent chemical reaction is more efficient. In the chemical reaction stage, by controlling the reaction time to be within a range of 1 to 6 hours and the reaction temperature to be within a range of 80 °C to 120 °C, the progress of the reaction is precisely controlled, the sufficiency and selectivity of the reaction are ensured, the increase of by-products caused by excessive reaction is avoided, and the low recovery efficiency caused by insufficient reaction is also avoided. The addition of the functionalized compound and the catalyst not only facilitates the decomposition of components of the waste tires, but also introduces new functional groups through functionalization reactions to improve the performance of devulcanized rubber, such that the recovered rubber has wider application prospects, especially in fields with higher requirements on performance, such as high-performance tire manufacturing and rubber product modification. In addition, by optimizing the reaction conditions and the use of chemical substances, the tire recovery method of the present disclosure significantly reduces energy consumption and environmental pollution while realizing high-efficiency recovery, complies with the requirements of sustainable development, and has significant economic benefits and social benefits.

In conclusion, the tire recovery method provided by the present disclosure not only increases the recovery efficiency and purity of waste tires, but also improves the performance of the recovered rubber by introducing the functionalized compound and the catalyst, thereby expanding the application range thereof.

### BRIEF DESCRIPTION OF THE DRAWINGS

The drawings of the description, constituting a part of the present disclosure, are used for providing further understanding of the present disclosure, and the illustrative embodiments of the present disclosure and illustrations thereof are used for explaining the present disclosure, rather than constitute inappropriate limitation on the present disclosure. In the drawings:

FIG. 1 illustrates a block diagram showing the hardware structure of a computer terminal of a tire recovery method according to some embodiments of the present disclosure; and

FIG. 2 illustrates a flowchart of a tire recovery method according to some embodiments of the present disclosure.

### DETAILED DESCRIPTION OF THE EMBODIMENTS

It is to be noted that embodiments in the present disclosure and features in the embodiments can combine with one another without conflicts. Hereinafter, the present disclosure is described in detail with reference to the accompanying drawings and in conjunction with the embodiments.

One of the core processes in the tire manufacturing industry is vulcanization, which chemically crosslinks elastomer molecular chains to construct a stable three-dimensional network structure, thereby imparting excellent mechanical performance and durability to a tire. However, the irreversibility of the vulcanization process also means that vulcanized rubber in waste tires cannot be directly reprocessed by means of melting or dissolution, which constitutes a major technical obstacle to the recycling of tires. Since the invention of vulcanized rubber, the recovery and reuse of waste tires have long troubled the rubber industry, and has become a challenge in urgent need of breakthroughs.

At present, waste tire recovery technologies are mainly divided into three major categories: rubber crushing, reuse, and devulcanization. The devulcanization technology aims to break polysulfide, disulfide and monosulfide bonds in vulcanized rubber, while for rubber vulcanized by peroxide or resin, it is necessary to cleave stronger carbon-carbon bonds or other chemical bonds. However, the devulcanized rubber, due to its molecular chain breakage and broadening of molecular weight distribution, tends to have decreased quality, resulting in a limited application range thereof, and the devulcanized rubber is difficult to use as raw materials for high-performance rubber products.

A main object of the present disclosure is to provide a tire recovery method, a storage medium, an electronic apparatus, and a computer product program, so as to solve the problem in the related art that it is difficult for devulcanized rubber to be used as raw materials for high-performance rubber products due to molecular chain breakage and broadening of molecular weight distribution of the devulcanized rubber.

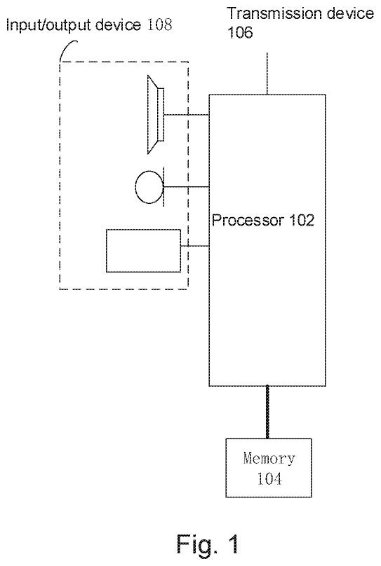

Method embodiments provided in embodiments of the present disclosure are executed in a computer terminal or a similar computing apparatus. Taking running the method on a computer terminal as an example, FIG. 1 is a block diagram showing the hardware structure of the computer terminal of a tire recovery method according to embodiments of the present disclosure. As shown in FIG. 1, the computer terminal includes: one or N (FIG. 1 shows only one) processors 102 (the processors 102 includes, but not limited to processing apparatus such as a micro processor (Central Processing Unit, MCU) or a programmable logic device (Field Programmable Gate Array, FPGA)); and a memory 104 for storing data, wherein the computer terminal further includes a transmission device 106 and an input/output device 108 for communication functions. A person of ordinary skill in the art would understand that the structure shown in FIG. 1 is merely exemplary, and does not limit the structure of the computer terminal. For example, the computer terminal also includes more or fewer assemblies than those shown in FIG. 1, or have different configurations from that shown in FIG. 1.

The memory 104 is used for storing a computer program, for example, a software program and module of application software, such as a computer program corresponding to the tire recovery method in embodiments of the present disclosure; and the processor 102 executes all functional applications and data processing by running the computer program stored in the memory 104, i.e. implementing the described method. The memory 104 includes a high-speed random access memory, and also includes a non-transitory memory, such as one or N magnetic storage apparatuses, flash memories or other non-transitory solid-state memories. In some embodiments of the present disclosure, the memory 104 further includes memories remotely arranged with respect to the processors 102, and these remote memories are connected to the computer terminal via a network. Examples of the network include, but are not limited to the Internet, an intranet, a local area network, a mobile communication network and combinations thereof.

The transmission device 106 is used to receive or transmit data via a network. Specific examples of the network includes a wireless network provided by a communication provider of the computer terminal. In some embodiments of the present disclosure, the transmission device 106 includes a network adapter (Network Interface Controller, NIC for short) which is connected to other network devices by means of a base station, thereby being able to communicate with the Internet. In one example, the transmission device 106 is a Radio Frequency (RF for short) module which is configured to communicate with the Internet in a wireless mode.

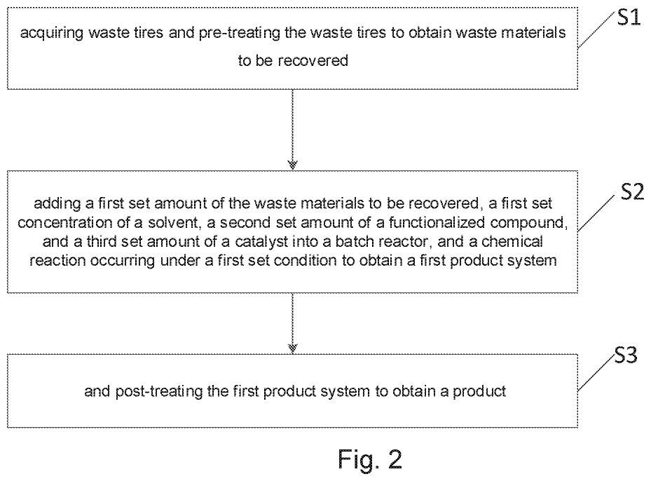

First, in some embodiments, the present disclosure provides a tire recovery method. As shown in FIG. 2, the tire recovery method includes:
S1. waste tires are acquired and pre-treated to obtain waste materials to be recovered;
in some embodiments of the present disclosure: the waste tires are crushed to obtain initial waste materials to be recovered, wherein the initial waste materials to be recovered have a shape in any one or more of block shape, sheet shape and powder shape; and
the initial waste materials to be recovered are controlled to be dried at a set drying temperature, so as to obtain the waste materials to be recovered;
wherein the set drying temperature is 100 °C.

In some embodiments of the present disclosure, the acquired waste tires are crushed using a rubber crushing apparatus to obtain initial waste materials to be recovered, the initial waste materials to be recovered have a shape in any one or more of block shape, sheet shape and powder shape, and the initial waste materials to be recovered have a size from 50 mesh to 200 mesh, which facilitates increase of the efficiency and uniformity of chemical reactions during subsequent processing; and then the initial waste materials to be recovered are dried at a drying temperature of 100 °C, so as to remove the moisture in the initial waste materials to be recovered and obtain the waste materials to be recovered.

By the technical solution of the present disclosure, the waste tires are no longer environment burdens, but become recyclable resources, and have important significance for promoting the circular economy and sustainable development.
S2. A first set amount of the waste materials to be recovered, a first set concentration of a solvent, a second set amount of a functionalized compound, and a third set amount of a catalyst are added into a batch reactor, and an inert gas is introduced into the batch reactor to remove oxygen from the reactor;
wherein the inert gas is any one of nitrogen and carbon dioxide, or the inert gas is a mixed gas of nitrogen and carbon dioxide, and a chemical reaction occurs under a first set condition to obtain a first product system, wherein the first set condition includes: a reaction time of 1 to 6 hours and a reaction temperature of 80 °C to 120 °;
a residence time of the inert gas in the batch reactor is controlled to be 30 minutes; and
a number of times of introducing the inert gas into the batch reactor is set to at least three times, and a time interval between every two adjacent times of introducing the inert gas is 5 min to 30 min; the solvent is any one of an alkane, a halogenated hydrocarbon, and a lipid; the first set concentration is 5% to 40%; and a functional group at one terminal of the functionalized compound is any one of maleic anhydride, sulfhydryl group and amine group, and the other terminal of the functionalized compound is a group which includes one of filler-dispersing, anti-aging and anti-reversion.

The groups associated with filler-dispersing include those derived from silane coupling agents, such as siloxy groups (—Si—O—) and methacryloxy groups; the groups associated with filler-dispersing also include polar groups introduced by polymer graft modification, including carboxyl groups (—COOH) and hydroxyl groups (—OH).

Anti-aging-associated functional groups include hindered phenolic groups and amine groups. Among them, the hindered phenolic groups refer to the hindered phenolic structure in 2,6-di-tert-butyl-4-methylphenol (BHT), while the amine groups include amino groups (—NH₂) in p-phenylenediamine-based antioxidants.

Functional groups associated with vulcanization resistance include thioether groups contained in sulfur-containing compounds, such as the thioether groups (—S—) in dilauryl thiodipropionate (DLTP). Functional groups associated with vulcanization resistance also include derived groups of hindered amine light stabilizers (HALS), such as piperidinyl groups (2,2,6,6-tetramethylpiperidinyl groups) present in some HALS derivatives.

In some embodiments of the present disclosure, the type of the catalyst is one or more of a metal ion compound and an amination reagent, and furthermore, the metal ion compound is a compound containing any one of palladium, copper, nickel, platinum, ruthenium, zinc and magnesium ions, and the amination reagent is a sulfodiimide, such as N,N′-dimethoxycarbonyl sulfodiimide (DMSD); N,N′-di-tert-butoxycarbonyl sulfodiimide (DTSD) and the like.

In some embodiments of the present disclosure, to ensure that all chemical reactions are carried out in an oxygen-free environment, so as to prevent oxidation side reactions from occurring during the reaction, this is achieved by introducing an inert gas (such as nitrogen, carbon dioxide, or a mixed gas of the two) into the batch reactor. The residence time of the inert gas in the batch reactor is controlled to be at least 30 minutes, which is to achieve sufficient replacement of oxygen in the batch reactor and ensure the inertness of the reaction environment. In addition, the inert gas is introduced multiple times (at least three times), and a time interval between two times of adjacent introductions is set as 5 to 30 minutes, such that the oxygen removal efficiency further increases, thereby ensuring smooth progress of the reaction.

Next, a first set amount of the waste materials to be recovered (e.g. pre-treated waste tire debris), a first set concentration of a solvent (e.g. alkane, halogenated hydrocarbon, or lipid solvent at a concentration between 5% to 40%), a second set amount of functionalized compound and a third set amount of catalyst are added into the batch reactor. The selection of the functionalized compound should take into consideration that the functional group at one terminal thereof can react with components in the tire waste, and the other terminal has a group which is e.g. filler-dispersing, anti-aging or anti-reversion, to improve the properties of the waste materials to be recovered. The addition of the catalyst accelerates the reaction and increases the reaction efficiency.

Under a set reaction condition (i.e. a first set condition, a reaction time of 1-6 hours and a reaction temperature of 80 °C-120 °C), these components will undergo chemical reactions to form the first product system. In order to further increase the purity and recovery of the product, after the reactions, ethanol can be added into the reactor and mixed with the first product system, so as to precipitate or separate the product, and the solvent is also recovered. The recovered solvent can be recycled after steps such as separation and rectification, thereby reducing the cost of the whole process, wherein the third set amount is 1/100 to 1/8000 of a total molar amount of the functionalized compound, the first set concentration is determined according to the minimum unit of the molecular structure of rubber, and the determination of the second set amount is determined according to the equivalent of reactive sites; and in chemical reactions, especially reactions involving a polymer material, the “equivalent of reactive sites” generally refers to the number of specific structures in a reactive molecule that can chemically react with another reactant. For the functionalized compound in the tire recovery process, the reactive sites refer to chemical groups capable of reacting with rubber molecules (usually a vulcanized rubber) in the waste tires, such as maleic anhydride, sulfhydryl group and amine group These groups can react with vulcanization sites or other specific functional groups on the rubber molecular chain, thereby realizing chemical modification or functionalization of the rubber. The value of the first set concentration of solvent needs to be determined according to the minimum unit of the molecular structure of rubber, and the specific steps are as follows: first, the type and molecular structure of the rubber in the waste tires are known. Different types of rubbers (e.g. natural rubber and styrene butadiene rubber) have different structural features and minimal repeat units. Depending on the molecular structure of the rubber, reactive sites thereof such as vulcanization sites or other functional groups are determined. Given a certain amount of waste tires, the total number of reactive sites in the waste materials is determined by means of chemical analysis or theoretical calculation. A suitable solvent is selected on the basis of the solubility of the rubber and the nature of the reactive sites. The nature of the solvent should promote or not affect the reaction between the functionalized compound and the rubber. The first set concentration of solvent is to ensure that the functionalized compound can sufficiently contact and react with the reactive sites in the rubber molecules. When calculating the solvent concentration, the following factors need to be considered: the solubility of the functionalized compound in the solvent; the reaction compatibility between the solvent and the functionalized compound and the catalyst; and the density of the reactive sites and the reactivity of the functionalized compound, i.e. ensuring that the reactive groups of the functionalized compound can effectively react with each reactive site. The first set concentration of solvent determined in the present disclosure is between 5% and 40%.

By using the functionalized compound and the catalyst, the tire recovery method of the present disclosure can effectively recover waste tires under mild reaction conditions, avoiding excessive breakage of rubber molecular chains and broadening of molecular weight distribution which may be caused in traditional recovery methods, thereby improving the quality of recovered materials. In addition, by controlling the reaction environment to be in an oxygen-free state, the occurrence of oxidation side reactions is reduced, and the product purity is further ensured. The recovery and reuse of the solvent reduces the production costs and improves economic benefits. As a whole, the method of the present disclosure not only solves the technical problem of recycling waste tires, but also has the advantages of environmental protection and economy, and is of great significance to promote the sustainable development of the tire industry.
S3. the first product system is post-treated to obtain a product;

In some embodiments of the present disclosure, an alcohol substance is introduced into the batch reactor, and mixed with the first product system, to obtain the product and an initial solvent; the initial solvent is sequentially separated and rectified to obtain the solvent;
wherein the alcohol substance is any one of methanol, ethanol, propanol, butanol, pentanol and hexanol.

The first set condition includes: a reaction time of 1 to 6 hours and a reaction temperature of 80 °C to 120 °C,

In some embodiments of the present disclosure, at the end of the reaction, the alcohol substance is immediately introduced into the batch reactor, wherein the alcohol substance is any one of methanol, ethanol, propanol, butanol, pentanol and hexanol; and one of the alcohol substances can be selected to be mixed with the first product system, and the amount of the alcohol substance should be sufficient to fully mix with the first product system, such that the chemical environment of the system is changed, thereby facilitating precipitation of the product or forming an easily-separated phase. In some embodiments of the present disclosure, the selected alcohol is ethanol, wherein the addition amount and speed of ethanol need to be adjusted appropriately, so as to avoid violent temperature changes or pressure fluctuations, and ensure safe operation. After mixing, the product and the solvent need to be separated by physical methods such as filtration and centrifugation. The product typically precipitates in the form of a precipitate or solid, and the solvent remains in a liquid phase. Impurities in the solvent separated from the mixture needs to be further removed by a rectification process, to restore its initial purity. Rectification is a separation technique based on boiling point difference of components in a liquid mixture, and by controlling the temperature and pressure, a high-purity solvent can be effectively separated and recovered.

In some embodiments of the present disclosure, the recovery and reuse of the solvent reduces the consumption of chemicals, reduces the processing costs, and also reduces potential pollution to the environment, thereby reflecting the concept of green chemistry and circular economy. By introduction of the functionalized compound and the specific post-treatment steps, the molecular weight distribution of the product can be controlled, thereby avoiding performance degradation caused by molecular chain breakage of rubber in traditional tire recovery methods, such that the recovered rubber has performance closer to that of native rubber, thereby expanding the application range thereof. An inert gas (such as nitrogen) is introduced into the batch reactor to remove oxygen, reducing the risk of explosion or combustion in the batch reactor, and ensuring the safety of the operation process. The present method combines chemical reactions and physical separation technologies, and achieves chemical bond selective breaking and high-efficiency separation of products in tire recovery processes. Compared with traditional methods, the present method has a higher conversion rate and selectivity, and provides a new route for high-value utilization of waste tires.

### Example 1

1 kg of recovered solution-polymerized styrene butadiene devulcanized rubber and 1 to 10 g of an anti-aging agent having one terminal group of maleic anhydride were added into a batch reactor; the batch reactor was heated at a temperature of 50 °C for 30 min, connected to a nitrogen storage

apparatus, and filled with nitrogen for 3-5 times under vacuum; purified hexane (hexane which has been purified, i.e. hexane formed after removing water and oxygen) was added under a nitrogen atmosphere; the temperature increased to a reaction temperature (80 °C to 120 °C) while stirring; a catalyst toluene solution was injected; and after reacting for 3-6 hours, terminating, settling, drying and purifying were performed, a devulcanized solution-polymerized styrene butadiene-maleic anhydride-anti-aging agent compound was obtained. Analysis after extraction reveals that the grafting rate can be in the range of 2%-20%, said compound can be used as an aid, and the particular method is to calculate the grafting rate by means of nuclear magnetism, and the specific calculation method belongs to the related art, and will not be described herein; wherein the catalyst toluene solution refers to a solution formed by dissolving a catalyst in a toluene solvent, and the toluene solution can better disperse the catalyst, such that the catalyst can uniformly contact the waste materials to be recovered, thereby effectively catalyzing the chemical reactions, and helps the functionalized compound to react with the components in the waste tires, to achieve a better recovery effect. As a good organic solvent, toluene can dissolve multiple organic substances, including rubber and some catalysts, and is one of solvents commonly used in chemical reactions, wherein the CAS number of maleic anhydride is 108-31-6, MDL is MFCD 00005518, and the manufacturer is Energy Chemical.

### Example 2

1 kg of recovered devulcanized natural rubber and 10 to 15 g of an anti-aging agent having one terminal group of sulfhydryl group were added into a batch reactor; the reactor was heated at 50 °C for 30 min, connected to a nitrogen storage apparatus, and filled with nitrogen for 3-5 times under vacuum; purified hexane (hexane which has been purified, i.e. hexane formed after removing water and oxygen) was added under a nitrogen atmosphere; the temperature increased to a reaction temperature (80 °C to 120 °C) while stirring; a catalyst toluene solution was injected; and after reacting for 0.5-3 hours, terminating, settling, drying and purifying were performed, a devulcanized natural rubber-monosulfide bond-anti-aging agent compound was obtained. Analysis after extraction shows that the grafting rate can be in a range of 3%-30%, wherein the CAS number of the sulfhydryl group is 68865-60-1, and the manufacturer is Energy Chemical.

### Example 3

1 kg of recovered solution-polymerized styrene butadiene devulcanized rubber and 2 to 8 g of a surfactant having one terminal group of maleic anhydride were added into a reactor; the reactor was heated at 50 °C for 30 min, connected to a nitrogen storage apparatus, and filled with nitrogen for 3-5 times under vacuum; purified hexane was added under a nitrogen atmosphere; the temperature increased to a reaction temperature while stirring; a catalyst toluene solution was injected; and after reacting for 2-5 hours, terminating, settling, drying and purifying were performed, a devulcanized solution-polymerized styrene butadiene-maleic anhydride-surfactant compound was obtained. Analysis after extraction shows that the grafting rate can be in a range of 2%-25%.

### Example 4

Taking a PCR (Passenger Car Radial) tire tread rubber compound formulation as a comparison standard, 20 g of devulcanized solution-polymerized styrene butadiene-maleic anhydride-surfactant compound was taken to replace SBR in the formulation at an equal amount for compounding, so as to obtain a comparison sample. The prepared reference sample was compared with the comparison sample before and after aging after acetone extraction, it has been found that the tensile product of the sample to which the devulcanized solution-polymerized styrene butadiene-maleic anhydride-surfactant compound has been added is improved by 15% compared with the reference sample.

In some embodiments of the present disclosure, PCR (Passenger Car Radial) refers to a passenger car radial tire, and the tire tread rubber compound formulation is a rubber compound formulation for manufacturing a tire tread layer, and is generally well-designed according to performance requirements (such as wear resistance, wet skid resistance, and rolling resistance) of the tire. Here, the original formulation is set as the reference to compare to obtain the improved effect. The devulcanized solution-polymerized styrene butadiene is recovered rubber obtained by treating waste tires by chemical means, maleic anhydride is a compound capable of improving the performance of high molecular materials, and the surfactant can enhance the dispersibility and compatibility of the material. A combination of the three replaces the SBR in the original formulation at an equal amount, which means that a part of original rubber is replaced with the recovered rubber material while keeping the total weight of the formulation unchanged, so as to test the performance thereof. Compounding is a process in which rubber is sufficiently mixed with additives (such as carbon black, a vulcanizing agent, and a promoter) at a high temperature. Two samples were prepared, one being a reference sample prepared according to the original formulation and the other being a comparative sample replacing a part of the SBR with the described compound. Acetone extraction is a common method for the separation of additives and non-rubber components in rubber. The extracted sample was subjected to an aging treatment, which simulates performance change of the product in use environments, generally including long-time high-temperature, light illumination or mechanical stress test. The tensile product is an indicator for measuring the product of tensile strength and elongation at break of a rubber material when the material is stretched, and reflects the comprehensive stretching property of the material. The comparison sample shows a 15% higher tensile product before and after aging than that of the reference sample, which indicates that the properties of the recovered rubber material to which the devulcanized solution-polymerized styrene butadiene-maleic anhydride-surfactant compound has been added are increased compared with a pure SBR material, especially in terms of abrasion resistance and mechanical strength.

Embodiments of the present disclosure further provide a computer-readable storage medium, the computer-readable storage medium storing a computer program, wherein the computer program is configured to execute the steps in any one of the method embodiments when running.

In some embodiments of the present disclosure, the storage medium may be configured to store a computer program for executing the following steps:
S1. waste tires are acquired and pre-treated to obtain waste materials to be recovered;
S2. a first set amount of the waste materials to be recovered, a first set concentration of a solvent, a second set amount of a functionalized compound, and a third set amount of a catalyst are added into a batch reactor, and a chemical reaction occurs under a first set condition to obtain a first product system; and
S3. the first product system is post-treated to obtain a product.

In some embodiments of the present disclosure, the computer-readable storage medium may include, but is not limited to: various media that can store a computer program, such as a USB flash drive, a Read-Only Memory (ROM for short), a Random Access Memory (RAM for short), a removable hard disk, a magnetic disk, or an optical disc.

For specific examples in the present embodiment, reference can be made to the examples described in the described embodiments and exemplary embodiments, and thus they will not be repeated again in the present embodiment.

Embodiments of the present disclosure further provide a computer program product, including a computer program, wherein the computer program, when executed by a processor, implements the steps in any one of the method embodiments.

Embodiments of the present disclosure further provide another computer program product, including a non-transitory computer-readable storage medium, the non-transitory computer-readable storage medium storing a computer program, wherein the computer program, when executed by a processor, implements the steps in any one of the method embodiments.

Embodiments of the present disclosure further provide an electronic apparatus, including a memory and a processor; wherein the memory stores a computer program, and the processor is configured to run the computer program to execute the steps in any one of the method embodiments.

In some embodiments of the present disclosure, the processor may be configured to execute the following steps by means of the computer program:
S1. waste tires are acquired and pre-treated to obtain waste materials to be recovered;
S2. a first set amount of the waste materials to be recovered, a first set concentration of a solvent, a second set amount of a functionalized compound, and a third set amount of a catalyst are added into a batch reactor, and a chemical reaction occurs under a first set condition to obtain a first product system; and
S3. the first product system is post-treated to obtain a product.

In some embodiments of the present disclosure, the electronic apparatus can further include a transmission device and an input/output device, wherein the transmission device is connected to the processor, and the input/output device is connected to the processor.

For specific examples in the present embodiment, reference is made to the examples described in the described embodiments and exemplary embodiments, and thus they will not be repeated again in the present embodiment.

The content above merely relates to preferred embodiments of the present disclosure, and is not intended to limit the present disclosure. For a person skilled in the art, the present disclosure may have various modifications and changes. Any modifications, equivalent replacements, improvements and the like made within the spirit and principle of the present disclosure shall all fall within the scope of protection of the present disclosure.

What is claimed is:

1. A tire recovery method, comprising:
acquiring waste tires and pre-treating the waste tires to obtain waste materials to be recovered;
adding a first set amount of the waste materials to be recovered, a first set concentration of a solvent, a second set amount of a functionalized compound, and a third set amount of a catalyst into a batch reactor, and a chemical reaction occurring under a first set condition to obtain a first product system; and
post-treating the first product system to obtain a product;
wherein the first set condition comprises: a reaction time of 1 to 6 hours and a reaction temperature of 80 °C to 120 °C.

2. The tire recovery method as claimed in claim 1, wherein
a functional group at one terminal of the functionalized compound is any one of maleic anhydride, sulfhydryl group and amine group, and an other terminal of the functionalized compound is a group which comprises one of filler-dispersing, anti-aging and anti-reversion.

3. The tire recovery method as claimed in claim 1, wherein a step of acquiring waste tires and pre-treating the waste tires to obtain waste materials to be recovered, comprises:
crushing the waste tires to obtain initial waste materials to be recovered, wherein the initial waste materials to be recovered have a shape in any one or more of block shape, sheet shape and powder shape; and
controlling the initial waste materials to be recovered to be dried at a set drying temperature, so as to obtain the waste materials to be recovered;
wherein the set drying temperature is 100 °C.

4. The tire recovery method as claimed in claim 1, wherein before a step of the chemical reaction occurring under the first set condition, the method further comprises:
introducing an inert gas into the batch reactor to remove oxygen from the batch reactor;
wherein the inert gas is any one of nitrogen and carbon dioxide, or the inert gas is a mixed gas of nitrogen and carbon dioxide.

5. The tire recovery method as claimed in claim 4, wherein
a residence time of the inert gas in the batch reactor is controlled to be 30 minutes; and
a number of times of introducing the inert gas into the batch reactor is set to at least three times, and a time interval between every two adjacent times of introducing the inert gas is 5 min to min.

6. The tire recovery method as claimed in claim 1, wherein
the solvent is any one of an alkane, a halogenated hydrocarbon, and a lipid; and
the first set concentration is 5% to 40%.

7. The tire recovery method as claimed in claim 1, wherein a step of post-treating the first product system to obtain the product, comprises:
introducing an alcohol substance into the batch reactor, and mixing the alcohol substance with the first product system, to obtain the product and an initial solvent;
wherein the alcohol substance is any one of methanol, ethanol, propanol, butanol, pentanol and hexanol.

8. The tire recovery method as claimed in claim 7, wherein after a step of obtaining the product and the solvent, the method further comprises:
sequentially separating and rectifying the initial solvent to obtain the solvent.

9. The tire recovery method as claimed in claim 3, wherein the initial waste materials to be recovered have a size from 50 mesh to 200 mesh.

10. The tire recovery method as claimed in claim 1, wherein the third set amount is 1/100 to 1/8000 of a total molar amount of the functionalized compound.

11. A computer-readable storage medium, the computer-readable storage medium comprising a stored program, wherein the program, when running, executes a tire recovery method, wherein the tire recovery method comprises: acquiring waste tires and pre-treating the waste tires to obtain waste materials to be recovered;
adding a first set amount of the waste materials to be recovered, a first set concentration of a solvent, a second set amount of a functionalized compound, and a third set amount of a catalyst into a batch reactor, and a chemical reaction occurring under a first set condition to obtain a first product system; and
post-treating the first product system to obtain a product;
wherein the first set condition comprises: a reaction time of 1 to 6 hours and a reaction temperature of 80 °C to 120 °C.

12. An electronic apparatus, comprising a memory and a processor, wherein the memory stores a computer program, and the processor is configured to run the computer program so as to execute a tire recovery method: wherein the tire recovery method comprises: acquiring waste tires and pre-treating the waste tires to obtain waste materials to be recovered;
adding a first set amount of the waste materials to be recovered, a first set concentration of a solvent, a second set amount of a functionalized compound, and a third set amount of a catalyst into a batch reactor, and a chemical reaction occurring under a first set condition to obtain a first product system; and
post-treating the first product system to obtain a product;
wherein the first set condition comprises: a reaction time of 1 to 6 hours and a reaction temperature of 80 °C to 120 °C.

13. The tire recovery method as claimed in claim 4, wherein
a residence time of the inert gas in the batch reactor is controlled to be 30 minutes; or
a number of times of introducing the inert gas into the batch reactor is set to at least three times, and a time interval between every two adjacent times of introducing the inert gas is 5 min to 30 min.

14. The tire recovery method as claimed in claim 1, wherein
the solvent is any one of an alkane, a halogenated hydrocarbon, and a lipid; or
the first set concentration is 5% to 40%.

15. The computer-readable storage medium as claimed in claim 11, wherein
a functional group at one terminal of the functionalized compound is any one of maleic anhydride, sulfhydryl group and amine group, and an other terminal of the functionalized compound is a group which comprises one of filler-dispersing, anti-aging and anti-reversion.

16. The computer-readable storage medium as claimed in claim 11, wherein a step of acquiring waste tires and pre-treating the waste tires to obtain waste materials to be recovered, comprises:
crushing the waste tires to obtain initial waste materials to be recovered, wherein the initial waste materials to be recovered have a shape in any one or more of block shape, sheet shape and powder shape; and
controlling the initial waste materials to be recovered to be dried at a set drying temperature, so as to obtain the waste materials to be recovered;
wherein the set drying temperature is 100 °C.

17. The computer-readable storage medium as claimed in claim 11, wherein before a step of the chemical reaction occurring under the first set condition, the method further comprises:
introducing an inert gas into the batch reactor to remove oxygen from the batch reactor;
wherein the inert gas is any one of nitrogen and carbon dioxide, or the inert gas is a mixed gas of nitrogen and carbon dioxide.

18. The computer-readable storage medium as claimed in claim 11, wherein
a residence time of the inert gas in the batch reactor is controlled to be 30 minutes; and
a number of times of introducing the inert gas into the batch reactor is set to at least three times, and a time interval between every two adjacent times of introducing the inert gas is 5 min to min.

19. The computer-readable storage medium as claimed in claim 11, wherein
the solvent is any one of an alkane, a halogenated hydrocarbon, and a lipid; and
the first set concentration is 5% to 40%.

20. The electronic apparatus as claimed in claim 12, wherein
wherein a step of post-treating the first product system to obtain the product, comprises:
introducing an alcohol substance into the batch reactor, and mixing the alcohol substance with the first product system, to obtain the product and an initial solvent;
wherein the alcohol substance is any one of methanol, ethanol, propanol, butanol, pentanol and hexanol.
